(19) United States
(12) Patent Application Publication
(10) Pub. No.: US 2009/0138954 A1
(43) Pub. Date: May 28, 2009

(54) SECURITY SYSTEM AND SECURING METHOD OF CALL SIGNALING MESSAGES FOR SESSION INITIATION PROTOCOL BASED VoIP SERVICE

(76) Inventors: Yong Geun Won, Seoul (KR); Chae Tae Im, Seoul (KR); Tai Jin Lee, Seoul (KR); Yoo Jae Won, Yongin-si (KR)

Correspondence Address: Charles N. J. Ruggiero;Ohlandt, Greeley, Ruggiero & Perle, L.L.P., 10th Floor, One Landmark Square, Stamford, CT, 06901-2682, US

(21) Appl. No.: 12/181,607

(22) Filed: Jul. 29, 2008

(30) Foreign Application Priority Data
Nov. 22, 2007 (KR) 10-2007-0119812

(51) Int. Cl. G06F 21/00

(52) U.S. Cl. 726/11

(57) ABSTRACT

Disclosed is a security system of a call signaling message. An object of the invention is to provide a security system and a securing method of a call signaling message, in which even when a call signaling message is leaked out and thus modified in a SIP (Session Initiation Protocol) based VoIP (Voice Over Internet Protocol) service, the modified message is blocked in advance to enable the VoIP service to be provided without an attack effect by the packets. When using the security system and the securing method of a call signaling message according to an embodiment of the invention, it is possible to prevent, in the SIP based VoIP service, a call signaling message from being modified to cause a call failure when requesting a call or during the call, and to block an attack on the call signaling message in advance.

### CROSS-REFERENCE TO RELATED APPLICATIONS

This application claims all benefits of Korean Patent Application No. 10-2007-0119812 filed on Nov. 22, 2007 in the Korean Intellectual Property Office, the disclosures of which are incorporated herein by reference.

### BACKGROUND

1. Technical Field

The present invention relates to a security system and a securing method of a call signaling message for a SIP (Session Initiation Protocol) based VoIP (Voice Over Internet Protocol) service. More specifically, the invention relates to a security system and a securing method of a call signaling message, which block a message of call signaling messages transmitted/received between a transmit terminal and a server, which violates a message grammar, includes block information registered in a block list or is not suitable for a session state of the message, thereby enabling a VoIP service to be provided without an effect by a modified packet and the like.

2. Description of the Related Art

A VoIP (Voice Over Internet Protocol) service is a common name of a service that provides a voice call using an IP network, and is an internet telephone service that is currently highlighted due to a convenient using method and low cost. In a telephone communication using the VoIP service, a call setup protocol is required. Among the various kinds of call setup protocols, a SIP (Session Initiation Protocol) is researched most actively.

The SIP based VoIP service is made with a call signaling message through the SIP and a call message using a RTP packet. Through the call signaling message, the information for a user registration, a request for call initiation and a call is exchanged. Through the call message, the voice packets corresponding to an actual call are exchanged. The SIP is defined in RFC 3261 (SIP: Session Initiation Protocol) that is the global standard prescribed by the International Standardization Organization IETF (Internet Engineering Task Force).

However, since the call signaling message and the voice packet are easily exposed, the VoIP service has such a security drawback that attacks such as payment avoidance, call termination, service denial or the like can be made on the service. This drawback is a potential threat to the VoIP service that is currently activated, and may give rise to a high damage when it causes a failure in the IP backbone network. Hence, it is needed a scheme to cope with the security threat to the VoIP service.

### SUMMARY OF THE DISCLOSURE

Accordingly, the present invention has been made to solve the above problems. An object of the invention is to provide a security system and a securing method of a call signaling message, in which even when a call signaling message is leaked out and thus modified in a SIP (Session Initiation Protocol) based VoIP (Voice Over Internet Protocol) service, the modified message is blocked in advance to enable the VoIP service to be provided without an attack effect by the packets.

In order to achieve the above object, there is provided a security system of a call signaling message comprising: a message suitability verifying module that receives call signaling messages transmitted between a terminal and a server, blocks a call signaling message of the received call signaling messages which does not correspond to a preset format, and forwards the call signaling messages that are not blocked; a filtering module that receives the call signaling messages from the message suitability verifying module, blocks a call signaling message of the received call signaling messages which includes block information registered in a block list stored in advance, and forwards the call signaling messages that are not blocked; and a message state verifying module that receives the call signaling messages from the filtering module, blocks a call signaling message of the received call signaling messages which does not correspond to a session state of the call signaling message, and transmits the call signaling messages that are not blocked to the terminal or server.

According to an embodiment of the invention, there is provided a securing method of a call signaling message comprising the steps of: (a) receiving, at a message suitability verifying module, call signaling messages transmitted/received between a terminal and a server; (b) blocking a call signaling message of the call signaling messages received in the step of (a), which does not correspond to a preset format, and forwarding the call signaling messages that are not blocked to a filtering module; (c) blocking a call signaling message of the call signaling messages forwarded in the step of (b), which includes block information registered in a block list stored in advance, and forwarding the call signaling messages that are not blocked to a message state verifying module; and (d) blocking a call signaling message of the call signaling messages forwarded in the step of (c), which does not correspond to a session state of the call signaling messages, and transmitting the call signaling messages that are not blocked to the terminal or server.

When using the security system and the securing method of a call signaling message according to an embodiment of the invention, it is possible to prevent, in the SIP based VoIP service, a call signaling message from being modified to cause a call failure when requesting a call or during the call, and to block an attack on the call signaling message in advance.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram showing a structure of a SIP based VoIP service system;

FIG. 2 is a block diagram showing a structure of a security system of a call signaling message according to an embodiment of the invention;

FIGS. 3 and 4 are schematic views that exemplarily show a session state transition of a server resulting from receiving a call signaling message in a SIP based VoIP service system;

FIGS. 5 and 6 are schematic views that exemplarily show a session state transition of a terminal resulting from receiving a call signaling message in a SIP based VoIP service system;

FIG. 7 is a flow chart showing each step of a securing method of a call signaling message according to an embodiment of the invention; and

FIG. 8 is a flow chart showing each step of a message state verifying process in a securing method of a call signaling message according to an embodiment of the invention.

### DETAILED DESCRIPTION OF THE INVENTION

Hereinafter, a preferred embodiment of the present invention will be described with reference to the accompanying drawings. In the following description of the present invention, a detailed description of known functions and configurations incorporated herein will be omitted when it may make the subject matter of the present invention rather unclear.

The invention provides a security system and a securing method of a call signaling message for coping with an attack that may be made in a process of transmitting/receiving a call signaling message between a terminal and a proxy server in a SIP (Session Initiation Protocol) based VoIP (Voice Over Internet Protocol) service.

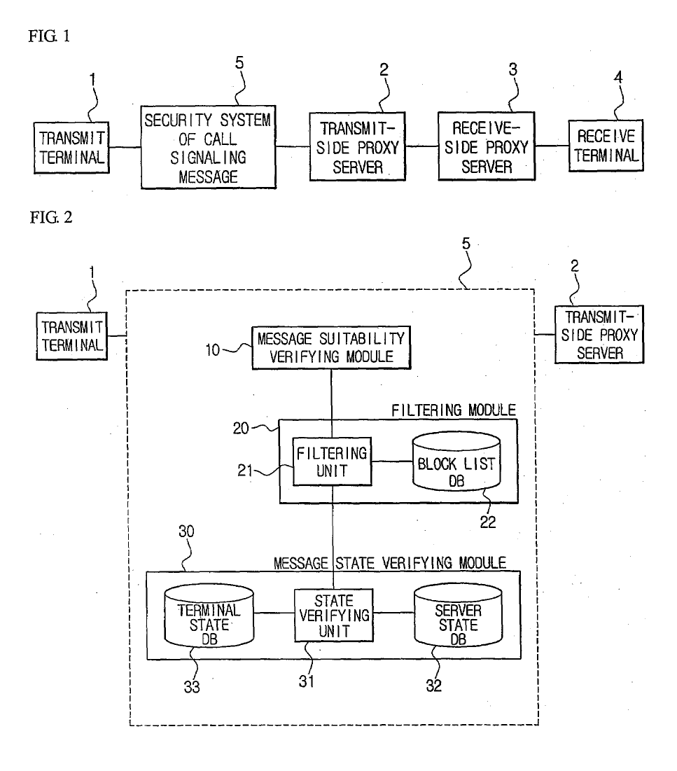

FIG. 1 is a block diagram showing a schematic structure of a SIP based VoIP service system. Referring to FIG. 1, when a transmitter requests a call connection using a terminal 1 that he/she carries, a voice call is connected between a terminal 4 of a receiver and the terminal 1 of the transmitter via a transmit-side proxy server 2 and a receive-side proxy server 3.

At this time, a security system 5 of a call signaling message according to an embodiment of the invention may be connected between the transmit terminal 1 and the transmit-side proxy server 2. However, contrary to the embodiment shown in FIG. 1, according to another embodiment of the invention, the security system 5 of a call signaling message may be connected between the receive terminal 4 and the receive-side proxy server 3. The security system 5 of a call signaling message receives a call signaling message that is transmitted/received between the terminal and the server, verifies whether the received message is suitable, whether the message includes information registered in a block list and whether the received message is a message suitable for a session state, blocks a harmful message and enables only a suitable message to be transmitted.

The SIP based call signaling messages are classified into a request message and a response message. The request message is a message for performing a request such as a session request, a call termination and a state confirmation, for example INVITE, Cancel, BYE, Option and the like. The response message is a response or error notifying message to a request, for example 100 Trying, 180 Ringing, 200 OK, ACK and the like. One of the call signaling messages is structured as shown in a table 1.

TABLE 1

| | |
|---|---|
| Start Line | INVITE sip:bob@biloxi.com SIP.2.0 |
| Massage | Via: SIP/2.0/UDP pc33.atlanta.com:branch=z9hGK776asdhds |
| Header | Max-Forwards: 70 |
| | To: Bob<sip:bob@biloxi.com |
| | From: Alice <sip.alice@atlanta.com>:tag=1928301774 |
| | Call-ID: a84b4c76e667@pc33.atlanta.com |
| | Cseq: 314159 INVITE |
| | Authorization: Digest username=“gkar” |
| | Contact: <sip: alice@pc33.atlanta.com> |
| | Content-Type: application/sdp |
| | Content-Length: 142 |
| | Route: <sip:p1.example.com:lr> |
| | Record-Route: <slp:p1.example.com:lr> |
| Massage | V=0 |
| Body | O=alice 2345566342 2346553445 IN IP4 pc33.atlanta.com |
| | S= |
| | C=IN IP4 pc33.atlanta.com |
| | T=0 0 |
| | M=audio 49170 RTP/AVP0 |
| | A=rtpmap:0 PCMU/8000 |

In the table 1, the start line includes a type of a message and receiver information. The message header includes mandatory information necessary for communication. The message body includes additional information necessary for communication.

In the SIP, items located in each row of the message header are referred to as fields. Among them, six fields of Via, Max-Forwards, To, From, Call-ID and CSeq are necessarily included as mandatory fields. The Via field indicates the information about hops through which the SIP message passes, the Max-Forwards field indicates the number of hops that are available for transmission, the To field indicates a receiver, the From field indicates a transmitter, the Call-ID field indicates an inherent identifier of a corresponding session and the CSeq field is a value that is increased by 1 (one) in accordance with a message order and indicates an identifier for identifying transaction that will be described below.

In addition, Route and Record-Route fields, which are additional fields, indicate a server address that will be necessarily passed through in transmission, and a server address that has been passed through, respectively. Moreover, an Authorization field indicates authorization-related information. The types of the SIP message and each field of the message header are specifically described in the RFC 3261 that is the global standard, and can be thus easily understood by one skilled in the art. Accordingly, the detailed descriptions thereof will be omitted.

FIG. 2 is a block diagram showing a structure of a security system of a call signaling message according to an embodiment of the invention. Referring to FIG. 2, the security system of a call signaling message according to the above embodiment comprises a message suitability verifying module 10, a filtering module 20 and a message state verifying module 30.

First, the message suitability verifying module 10 receives a call signaling message that is transmitted/received for a call signaling between the server 2 and the terminal 1 and parses each field value from the received message. Then, the message suitability verifying module 10 examines whether the values described in each field are made in accordance with the description format of the SIP. As described above, the values and formats described in each field of a call signaling message are defined in the RFC 3261 standard.

In one embodiment of the invention, the message suitability verifying module 10 may examine whether harmful information is included in the value of each field of the call signaling message. Here, the harmful information means an unsuitable character string having a possibility of detouring a user authorization of a server in the VoIP service, for example a special character or a SQL (Structured Query Language) command, which deviate from a description format of the SIP. The message suitability verifying module 10 determines whether a message is suitably prepared in each value of the mandatory fields of a call signaling message such as From, To, Via, Call-ID, Max-Forwards and CSeq fields, the extended fields such as Route and Record-Route fields or the authorization-related fields such as Authorization and Proxy-Authorization fields, and retrieves the harmful information to determine whether the corresponding message is modified.

When it is determined that the field value is unsuitable or the harmful information is included, as a result of the retrieval, the corresponding message is blocked by the message suitability verifying module 10 and the messages that are not blocked are forwarded to the filtering module that will be described below.

The filtering module 20 is a module for receiving a call signaling message from the message suitability verifying module 10, for which the verification has been completed, and blocking a message including block information registered in a block list stored in advance. The module comprises a block list DB 22 and a filtering unit 21.

A block list that is based on the fields of the SIP call signaling message is stored in advance in the block list DB 22. For example, the block list is a character string for the field values of the SIP call signaling message. According to an embodiment of the invention, the block list may be inputted in advance to the block list DB 22 by a service provider, or alternatively, may be stored in the block list DB 22 through an intrusion detection system (IDS) for the SIP protocol.

The filtering unit 21 filters the call signaling message using the block list stored in the block list DB 22. In one embodiment of the invention, the filtering unit 21 compares each field value of the header of the call signaling message with the character string registered in the block list. When any one field includes the character string in the block list, the filtering unit blocks the corresponding call signaling message. That is, when the character string recorded in the fields of a call signaling message, such as From, To, Via, Route, Record-Route and the like, is registered in the block list, the corresponding call signaling message is blocked.

The block lists stored in the block list DB 22 may be inputted by receiving the block-lists already-collected from an administrator before the filtering unit 21 operates, or may be inputted through an analysis of a result detected in the intrusion detection system (IDS) for the SIP protocol. The invention is not limited to a method of recording the block list.

The state verifying module 30 receives a call signaling message for which the verification has been completed by the message suitability verifying module 10 and the filtering module 20, and verifies whether the call signaling message corresponds to a session state stored in a terminal or server that will receive the corresponding message, based on a transaction flow of a call signaling message disclosed in the RFC 3261. If the call signaling message does not correspond to a session state, the state verifying module 30 determines that the corresponding call signaling message is modified and thus blocks the message.

The SIP is a transaction based protocol in which a call signaling message transits a corresponding session state of a transaction layer of a terminal or server that has received the corresponding call signaling message. The transaction layer is a functional module that is used to receive a signaling message in a server or terminal in accordance with a call connection state. The types of a message that a server or terminal can receive are different in accordance with the state transition. Accordingly, the invention uses this to select and block an unsuitable message.

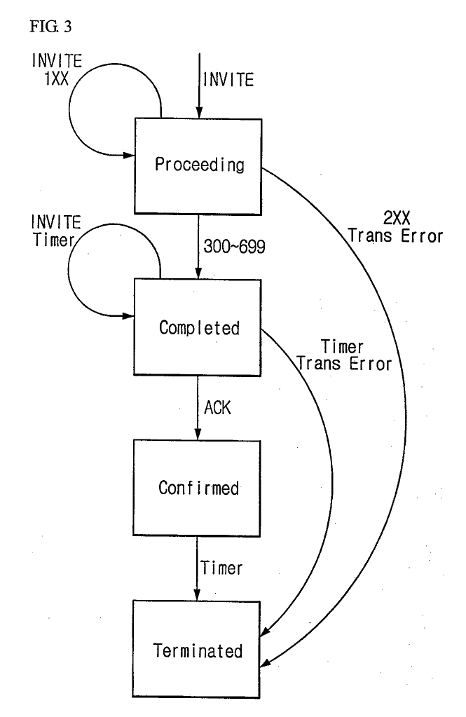

FIGS. 3 to 6 are schematic views that exemplarily show session state transitions of transaction layers of a server and a terminal by a call signaling message. In a SIP based communication, changes in session states of a server and a terminal resulting from receiving an INVITE message, which is a message requesting a call connection, and a message except the INVITE message are specifically defined in the RFC 3261. Hence, since one skilled in the art can easily understand the changes in the session states, the changes will be just schematically described in the specification.

FIG. 3 shows a session state transition of a server resulting from receiving an INVITE message for starting a call when the INVITE message is introduced into a server. The rectangles indicate session states of a server, the arrows between the rectangles indicate state transitions and the characters or numbers written near the arrows indicate types of messages necessary for a state transition.

Referring to FIG. 3, when an INVITE message is originally introduced into a server, a session state of the server is transited to a Proceeding state. Under this state, the server can receive the messages, for example INVITE message, 1XX response, 2XX response, 3XX to 699 response and transport error. In addition, when 300 to 699 response is received, the session state is transited to a Completed state. Moreover, when an ACK message is received under the Completed state, the session state is transited to a Confirmed state. When a Timer message is received under the Confirmed state, the session state is transited to a Terminated state.

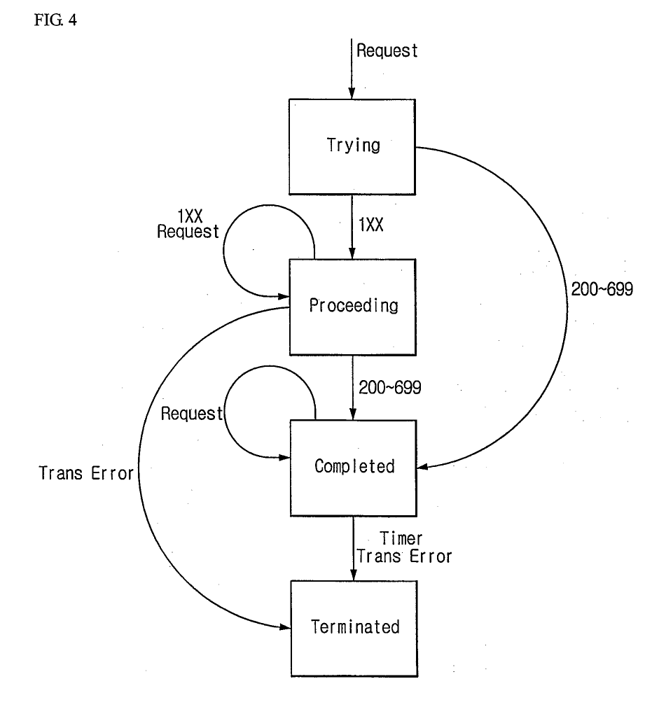

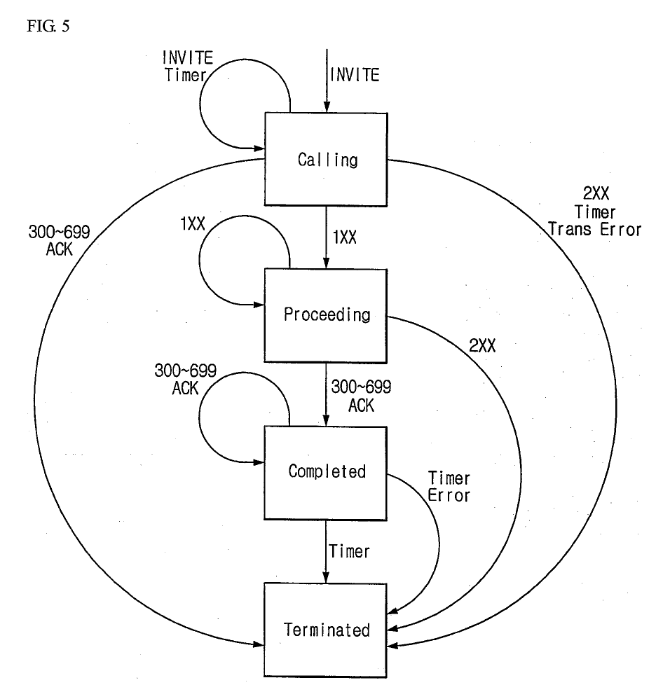

FIG. 4 shows a session state transition of a server and a type of a message that can be received at each state, when a message except the INVITE message is received. As shown, a session state is transited to Trying, Proceeding, Completed and Terminated states in accordance with the messages received.

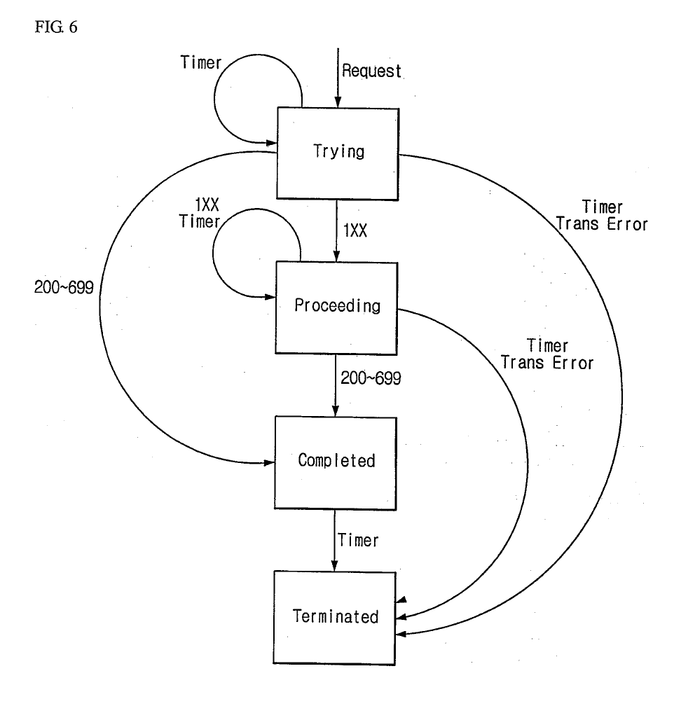

Meantime, FIGS. 5 and 6 show a change in a session state of a terminal resulting from receiving an INVITE message and a message except the INVITE message, respectively. Referring to FIG. 5, a session state of a terminal having received an INVITE message is transited to Calling, Proceeding, Completed and Terminated states in accordance with a message state. In the meantime, referring to FIG. 6, a session state of a terminal having received a message except the INVITE message is transited to Trying, Proceeding, Completed and Terminated states in accordance with a message state. Also in FIGS. 5 and 6, the types of the messages necessary for a transition between the respective states and the state transitions are indicated by the characters and the arrows, likewise FIG. 3.

Referring back to FIG. 2, the state verifying module 30 comprises a server state DB 32, a terminal state DB 33 and a state verifying unit 31. The server state DB 32 stores session state information of a transaction layer of a server and the terminal state DB 33 stores session state information of a transaction layer of a terminal. The state verifying unit 31 receives a call signaling message from the filtering module 20 and refers to the server or terminal, which will receive the call signaling message, for the state information of the corresponding session, thereby verifying whether the message is suitable.

In the SIP based VoIP, each call that is controlled by a call signaling message has an inherent value recorded in a Call-ID field and the like of the message header. The state verifying unit 31 retrieves the inherent value from the server state DB 32 or terminal state DB 33, thereby referring to a terminal or server, which will receive the call signaling message forwarded, for a corresponding session state.

To be more specific, when a call signaling message to be transmitted to the transmit-side proxy server 2 from the transmit terminal 1 is forwarded, the state verifying unit 31 refers to the server state DB 32 for the corresponding session state information of the transmit-side proxy server 2 that will receive the message. When the forwarded call signaling message is suitable for a current state, the state verifying unit 31 transmits the corresponding message to the transmit-side proxy server 2. When the forwarded call signaling message is not suitable for a current state, the state verifying unit 31 blocks the corresponding message while considering it as a modified message. For example, referring to FIG. 3, when the transmit-side proxy server 2 is under the Completed state, as a result that the state verifying unit 31 refers to the server state DB 32, if a 1XX or 2XX message is introduced from the filtering module 20, this does not correspond to the current session state of the transmit-side proxy server 2, so that the corresponding call signaling message is blocked.

To the contrary, when a call signaling message to be transmitted to the transmit terminal 1 from the transmit-side proxy server 2 is forwarded, the state verifying unit 31 refers to the terminal state DB 33 for the corresponding session state information of the transmit terminal 1. Likewise, when the call signaling message is suitable for a current state of the transmit terminal 1, the state verifying unit 31 transmits the corresponding message to the transmit terminal 1. When the call signaling message is not suitable for a current state of the transmit terminal 1, the state verifying unit 31 blocks the corresponding message while considering it as a modified message.

Furthermore, in an embodiment of the invention, when the session state information corresponding to the call signaling message forwarded from the filtering module 20 is not stored in the server state DB 32 or terminal state DB 33, the state verifying unit 31 may store a change in a session state of the server or terminal due to the corresponding call signaling message in the corresponding DB.

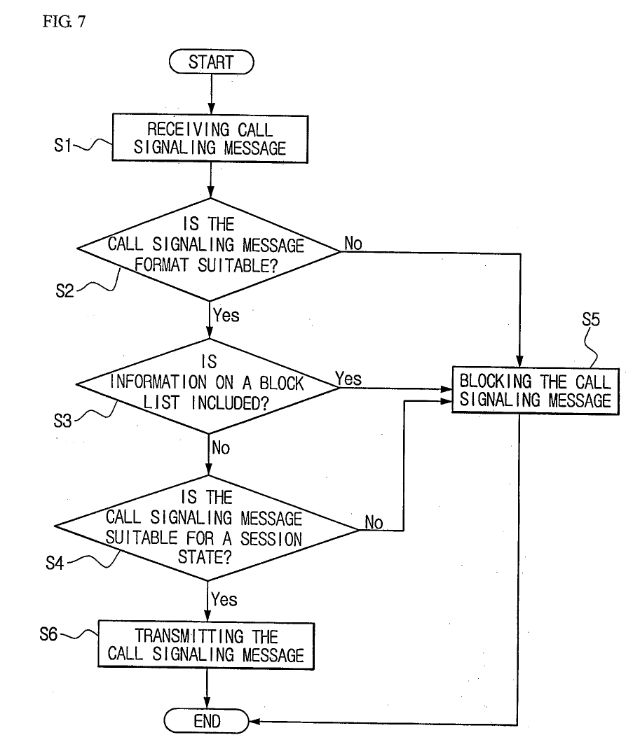

FIG. 7 is a flow chart showing each step of a securing method of a call signaling message according to an embodiment of the invention. Referring to FIGS. 2 and 7, a securing method of a call signaling message according to the embodiment is started as the message suitability verifying module 10 receives a SIP based call signaling message from the terminal or server (S1). The message suitability verifying module 10 divides the received call signaling message into each field value and examines whether each field of the message is suitable for a preset format, particularly the preset harmful information such as special character or SQL (Structured Query Language) command is included in the authorization field (S2). The message having an unsuitable message type or harmful information is blocked by the message suitability verifying module 10 (S5).

The message suitability verifying module 10 forwards the call signaling message having the suitable message to the filtering module 20. The filtering module 20 examines whether the forwarded call signaling message includes a character string of the field registered in the block list (S3). The message having a character string of the field in the block list is blocked by the filtering module 20 (S5). The character string of the field registered in the block list may include, for example an address of a server that transmits a modified packet, and the like. The block list having the character strings for the fields is stored in advance in the block list DB 22. The filtering unit 21 of the filtering module 20 refers to the block list DB 22 for the block list, thereby blocking a corresponding call signaling message.

The call signaling message for which the filtering has been completed by the filtering module 20 is forwarded to the message state verifying module 30. The message state verifying module 30 determines whether the forwarded call signaling message is suitable for a corresponding session state in the server or terminal that will receive the call signaling message (S4). The call signaling message, which is not suitable for the state of the terminal or server that will receive the message, is blocked (S5).

The session state information of the SIP based terminal or server is stored in the terminal state DB 33 and the server state DB 32, respectively. The state verifying unit 31 of the state verifying module 30 refers to the terminal state DB 33 or server state DB 32 in accordance with the object that will receive the call signaling message, thereby selectively blocking the unsuitable message. Meantime, the other call signaling messages not blocked are transmitted to the terminal or server in accordance with the object that will receive the message (S6).

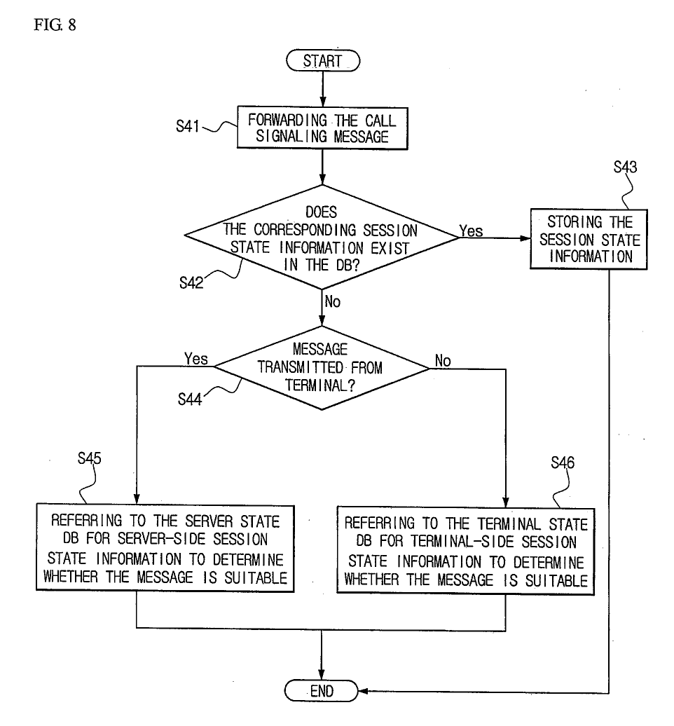

FIG. 8 is a flow chart showing each step of a state verifying process of a call signaling message in a securing method of a call signaling message according to an embodiment of the invention. Referring to FIGS. 2 and 8, the state verifying module 30 receives a call signaling message from the filtering module 20 (S41). When the call signaling message is forwarded, the state verifying unit 31 of the state verifying module 30 refers to the server state DB 32 or terminal state DB 33 so as to check whether the session state information corresponding to the call signaling message is stored therein (S42).

For example, when the call signaling message is transmitted to the terminal from the server, the state verifying unit 31 refers to the terminal state DB 33. When the call signaling message is transmitted to the server from the terminal, the state verifying unit refers to the server state DB 32. In an embodiment of the invention, when the session state information corresponding to the call signaling message is not stored, as a result of referring to the server state DB 32 or terminal state DB 33, the state verifying unit 31 may store the session state information by the call signaling message in the server state DB 32 or terminal state DB 33 (S43).

As a result of referring to the server state DB 32 or terminal state DB 33, when the session state information corresponding to the forwarded call signaling message is stored therein, the state verifying unit 31 determines whether the corresponding call signaling message is a message transmitted from the terminal (S44). When the call signaling message is transmitted from the terminal, the state verifying unit refers to the server state DB 32 to determine whether the call signaling message is suitable for the current session state of the server (S45). In the meantime, when the call signaling message is not a message transmitted from the terminal, i.e., when the call signaling message is transmitted from the server, the state verifying unit refers to the terminal state DB 33 to determine whether the call signaling message is suitable for the current session state of the terminal (S46).

When using the security system and the securing method of a call signaling message according to an embodiment of the invention, it is possible to block a call signaling message of the call signaling messages transmitted/received in a SIP based VoIP service, which is not suitable for a format, includes the harmful information, includes a character string of a field registered in the block list or does not correspond to the transaction state of the terminal or server that will receive the message, thereby preventing a modified call signaling message from being introduced. Hence, it is possible to prevent a call failure from being caused when requesting a call or during the call in the VoIP service, and to block an attack on a call signaling message in advance.

While the invention has been shown and described with reference to certain preferred embodiments thereof, it will be understood by those skilled in the art that various changes in form and details may be made thereto without departing from the spirit and scope of the invention as defined by the appended claims.

What is claimed is:

1. A security system of a call signaling message comprising:
a message suitability verifying module that receives call signaling messages transmitted between a terminal and a server, blocks a call signaling message of the received call signaling messages which does not correspond to a preset format, and forwards the call signaling messages that are not blocked;
a filtering module that receives the call signaling messages from the message suitability verifying module, blocks a call signaling message of the received call signaling messages which includes block information registered in a block list stored in advance, and forwards the call signaling messages that are not blocked; and
a message state verifying module that receives the call signaling messages from the filtering module, blocks a call signaling message of the received call signaling messages which does not correspond to a session state of the call signaling message, and transmits the call signaling messages that are not blocked to the terminal or server.

2. The security system according to claim 1, wherein the preset format is based on a standard of RFC 3261.

3. The security system according to claim 1, wherein the message suitability verifying module blocks a call signaling message of the received call signaling messages which includes preset harmful information, and
wherein the preset harmful information is a special character and a SQL (Structured Query Language) command.

4. The security system according to claim 1, wherein the call signaling message comprises a plurality of fields, and
wherein the filtering module comprises:
a block list DB that stores a block list in which one or more character strings for the one or more fields are registered, and
a filtering unit that blocks a call signaling message including the one or more character strings registered in the block list.

5. The security system according to claim 1, wherein the terminal and the server store session state information corresponding to the call signaling messages,
wherein the session state is transited between a plurality of preset states as the call signaling messages are received, and
wherein the state verifying module comprises:
a server state DB that stores the session state information of the server;
a terminal state DB that stores the session state information of the terminal, and
a state verifying unit that refers to the server state DB or the terminal state DB to block a call signaling message that does not correspond to the session state of the terminal or server that will receive the forwarded call signaling message.

6. The security system according to claim 5, wherein when the session state information corresponding to the forwarded call signaling message is not stored in the server state DB or terminal state DB as a result of referring to the server state DB or terminal state DB, the state verifying unit stores the session state information corresponding to the call signaling message in the server state DB or terminal state DB.

7. The security system according to claim 1, wherein the call signaling messages are generated using the SIP (Session Initiation Protocol).

8. A securing method of a call signaling message comprising the steps of:
(a) receiving, in a message suitability verifying module, call signaling messages transmitted between a terminal and a server;
(b) blocking a call signaling message of the call signaling messages received in the step of (a), which does not correspond to a preset format, and forwarding the call signaling messages that are not blocked to a filtering module;
(c) blocking a call signaling message of the call signaling messages forwarded in the step of (b), which includes block information registered in a block list stored in advance, and forwarding the call signaling messages that are not blocked to a message state verifying module; and
(d) blocking a call signaling message of the call signaling messages forwarded in the step of (c), which does not correspond to a session state of the call signaling messages, and transmitting the call signaling messages that are not blocked to the terminal or server.

9. The securing method according to claim 8, wherein the preset format is based on a standard of RFC 3261.

10. The securing method according to claim 8, wherein the step (b) comprises a step of blocking a call signaling message of the received call signaling messages which includes preset harmful information, and
wherein the preset harmful information is a special character and a SQL (Structured Query Language) command.

11. The securing method according to claim 8, wherein the call signaling message comprises a plurality of fields,
wherein the block list stored in advance comprises one or more character strings for the one or more fields of the call signaling message, and
wherein the step (c) comprises a step of blocking a call signaling message including the one or more character strings included in the block list.

12. The securing method according to claim 8, wherein the terminal and the server store session state information corresponding to the call signaling messages,
wherein the session state is transited between a plurality of preset states as the call signaling messages are received, and
wherein the step (d) comprises a step of:
referring to a terminal state DB or server state DB for the session state information of the terminal or server that will receive the forwarded call signaling message.

13. The securing method according to claim 12, wherein the step (d) further comprises a step of:
when the session state information corresponding to the forwarded call signaling message is not stored in the terminal state DB or server state DB, storing the session state information corresponding to the call signaling message in the server state DB or terminal state DB.

14. The securing method according to claim 8, wherein the call signaling messages are generated using the SIP (Session Initiation Protocol).
